(19) United States
(12) Patent Application Publication
(10) Pub. No.: US 2025/0023071 A1
(43) Pub. Date: Jan. 16, 2025

(54) METHOD AND SYSTEM FOR MANAGING A FUEL CELL STACK

(71) Applicant: GM GLOBAL TECHNOLOGY OPERATIONS LLC, Detroit, MI (US)

(72) Inventors: Anusorn Kongkanand, Rochester Hills, MI (US); Paul T. Yu, Lake Orion, MI (US); Wenbin Gu, Sterling Heights, MI (US)

(73) Assignee: GM GLOBAL TECHNOLOGY OPERATIONS LLC, Detroit, MI (US)

(21) Appl. No.: 18/350,126

(22) Filed: Jul. 11, 2023

(51) Int. Cl. H01M 8/04223; H01M 4/92; H01M 8/04119; H01M 8/04746; H01M 8/0668

(52) U.S. Cl. CPC H01M 8/04231; H01M 4/926; H01M 8/04119; H01M 8/04753; H01M 8/0668

(57) ABSTRACT

A fuel cell system and associated method of operation includes assembling a fuel cell stack including an exhaust valve, flowing a premixed gas containing carbon monoxide therethrough; and closing the exhaust valve, including prior to storage. Subsequently, the exhaust valve may be opened and a refresh operation may be executed to purge the carbon monoxide from the fuel cell stack.

### INTRODUCTION

The disclosure relates to a fuel cell system including a fuel cell stack having a platinum catalyst layer.

A fuel cell is an electrochemical device composed of multiple anode electrodes that receive hydrogen (H₂), multiple cathode electrodes that receive oxygen (O₂), and multiple electrolytes or an electrolyte solution interposed between each anode and cathode. An electrochemical reaction is induced to oxidize hydrogen molecules at the anode to generate protons (H+), which are then passed through the electrolyte for reduction at the cathode with an oxidizing agent, such as oxygen. This reaction creates electrons at the anode, some of which are redirected through a load, such as a vehicle's traction motor or a non-vehicular load requiring stationary power generation, before being sent to the cathode. Such a fuel cell may be used in combination with other fuel cells to form a fuel cell stack. This stack of fuel cells or fuel cell stack may be electrically connected to each other, for example, in series, such that the voltage supplied by each fuel cell is added to the next, such that a total voltage supplied by the fuel cell stack is the sum of the voltages of each of the stacked fuel cells.

Electrified drivetrains, e.g., hybrid-electric and fully electric systems may utilize a fuel cell system to supply power for one or more electric traction motors. One factor that determines the commercial viability of a fuel cell is its durability. A fuel cell for an automotive vehicle with an electric-drive powertrain may be tasked to provide at least 30,000 hours of service. Such high durability requirements may present a challenge to one or more components of a fuel cell.

A fuel cell may employ a platinum nanoparticle that is supported on carbon black particles. Over a period of time, the carbon black particles may be oxidized to CO₂, in presence of Pt catalyst, acidic electrolyte, and O₂. On known fuel cell systems, in preparation for long-term storage, it is known to purge the stack with hydrogen gas to protect electrodes oxygen that is in ambient air. However, ambient air may enter into the stack either through the intake, the tailpipe, or seal permeation. Intruded oxygen may cause carbon corrosion in two primary ways. Carbon corrosion may occur due to slow oxidation of carbon black as it is stored under oxygen atmosphere. Carbon corrosion may occur when both hydrogen and oxygen are present in the same side of the channel. In this case, the hydrogen may become a fuel to rapidly oxidize carbon black., which may lead to a corrosion reaction of the carbon black particles that is fueled by hydrogen.

### SUMMARY

On a fuel cell system having a fuel cell stack that employs carbon black particles as support for platinum nanoparticles, there is a need to provide a method and system to minimize or eliminate risk of oxidation of the carbon black particles contained therein during extended periods of inactivity, e.g., during shipping or long-term storage of the fuel cell stack.

An aspect of the disclosure may include a method for operating a fuel cell system that includes assembling a fuel cell stack including an exhaust valve; flowing a premixed gas containing carbon monoxide therethrough; and closing the exhaust valve.

Another aspect of the disclosure may include opening the exhaust valve; and executing a refresh operation to purge the carbon monoxide from the fuel cell stack.

Another aspect of the disclosure may include executing the refresh operation to purge the carbon monoxide from the fuel cell stack by flowing ambient air through the fuel cell stack.

Another aspect of the disclosure may include the fuel cell stack including an anode and a cathode, wherein executing the refresh operation to purge the carbon monoxide from the fuel cell stack includes flowing ambient air through the cathode.

Another aspect of the disclosure may include flowing the premixed gas containing carbon monoxide therethrough by flowing a premixed gas containing carbon monoxide and hydrogen therethrough.

Another aspect of the disclosure may include flowing the premixed gas containing hydrogen (H₂) and carbon monoxide (CO) at a ratio of 99.95% H₂ to 0.05% CO.

Another aspect of the disclosure may include flowing a premixed gas containing carbon monoxide and nitrogen.

Another aspect of the disclosure may include flowing a premixed gas containing carbon monoxide and argon.

Another aspect of the disclosure may include flowing a premixed gas containing carbon monoxide and helium.

Another aspect of the disclosure may include flowing a premixed gas containing at least 0.01% concentration of CO therethrough.

Another aspect of the disclosure may include a method for operating a fuel cell stack that includes flowing a gas containing carbon monoxide through the fuel cell stack for a predetermined time period; and then sealing the fuel cell stack from intrusion of air.

Another aspect of the disclosure may include a fuel cell system that has a fuel cell stack including an anode and a cathode that are separated by a fuel cell membrane. The anode has a first catalyst layer, a first micro-porous layer, a first gas diffusion layer and a first bipolar plate, and the cathode has a second catalyst layer, a second micro-porous layer, a second gas diffusion layer, and a second bipolar plate. The second catalyst layer includes a carbon support and platinum-based catalyst nanoparticles that are dispersed on the carbon support, wherein the carbon support of the second catalyst layer of the fuel cell stack is protected from corrosion during storage by imposition of carbon monoxide gas on the first catalyst layer.

The above summary is not intended to represent every possible embodiment or every aspect of the present disclosure. Rather, the foregoing summary is intended to exemplify some of the novel aspects and features disclosed herein. The above features and advantages, and other features and advantages of the present disclosure, will be readily apparent from the following detailed description of representative embodiments and modes for carrying out the present disclosure when taken in connection with the accompanying drawings and the claims.

### BRIEF DESCRIPTION OF THE DRAWINGS

One or more embodiments will now be described, by way of example, with reference to the accompanying drawings, in which:

FIG. 1 schematically illustrates a fuel cell system including a fuel cell stack in accordance with the disclosure.

FIG. 2 schematically illustrates a process for a fuel cell stack of a fuel cell system, in accordance with the disclosure.

The appended drawings are not necessarily to scale, and may present a somewhat simplified representation of various preferred features of the present disclosure as disclosed herein, including, for example, specific dimensions, orientations, locations, and shapes. Details associated with such features will be determined in part by the particular intended application and use environment.

### DETAILED DESCRIPTION

The components of the disclosed embodiments, as described and illustrated herein, may be arranged and designed in a variety of different configurations. Thus, the following detailed description is not intended to limit the scope of the disclosure, as claimed, but is merely representative of possible embodiments thereof. In addition, while numerous specific details are set forth in the following description in order to provide a thorough understanding of the embodiments disclosed herein, some embodiments may be practiced without some of these details. Moreover, for the purpose of clarity, certain technical material that is understood in the related art has not been described in detail in order to avoid unnecessarily obscuring the disclosure.

For purposes of convenience and clarity, directional terms such as top, bottom, left, right, up, over, above, below, beneath, rear, and front, may be used with respect to the drawings. These and similar directional terms are not to be construed to limit the scope of the disclosure. Furthermore, the disclosure, as illustrated and described herein, may be practiced in the absence of an element that is not specifically disclosed herein.

The following detailed description is merely illustrative in nature and is not intended to limit the application and uses. Furthermore, there is no intention to be bound by an expressed or implied theory presented herein. Throughout the drawings, corresponding reference numerals indicate like or corresponding parts and features.

As used herein, the term “system” may refer to one of or a combination of mechanical and electrical actuators, sensors, controllers, application-specific integrated circuits (ASIC), combinatorial logic circuits, software, firmware, and/or other components that are arranged to provide the described functionality.

As employed herein, the term “upstream” and related terms refer to elements that are towards an origination of a flow stream relative to an indicated location, and the term “downstream” and related terms refer to elements that are away from an origination of a flow stream relative to an indicated location.

The use of ordinals such as first, second and third does not necessarily imply a ranked sense of order, but rather may distinguish between multiple instances of an act or structure.

Embodiments may be described herein in terms of functional and/or logical block components and various processing steps or operations. Such block components may be realized by combinations or collections of mechanical and electrical hardware, software, and/or firmware components configured to perform the specified functions.

Detailed embodiments related to the present disclosure are disclosed herein. It is understood that the disclosed embodiments are merely illustrative of the disclosure that may be embodied in various and alternative forms. Specific structural and functional details disclosed herein are not to be interpreted as limiting, but merely as a representative basis for teaching one skilled in the art to variously employ the present disclosure.

All numerical values of parameters (e.g., of quantities or conditions) in this specification, including the appended claims, are to be understood as being modified in all instances by the term “about” whether or not “about” actually appears before the numerical value. “About” indicates that the stated numerical value allows some slight imprecision (with some approach to exactness in the value; about or reasonably close to the value; nearly). If the imprecision provided by “about” is not otherwise understood in the art with this ordinary meaning, then “about” as used herein indicates at least variations that may arise from ordinary methods of measuring and using such parameters. In addition, disclosure of ranges includes disclosure of all values and further divided ranges within the entire range. Each value within a range and the endpoints of a range are hereby all disclosed as separate embodiments.

The present disclosure relates to a fuel cell system that has a fuel cell stack including an anode and a cathode that are separated by a fuel cell membrane. The anode has a first catalyst layer, a first micro-porous layer, a first gas diffusion layer and a first bipolar plate, and the cathode has a second catalyst layer, a second micro-porous layer, a second gas diffusion layer, and a second bipolar plate. The second catalyst layer includes a carbon support and platinum-based catalyst nanoparticles that are dispersed on the carbon support, wherein the carbon support of the second catalyst layer of the fuel cell stack is protected from corrosion during storage by imposition of carbon monoxide gas on the first and second catalyst layers.

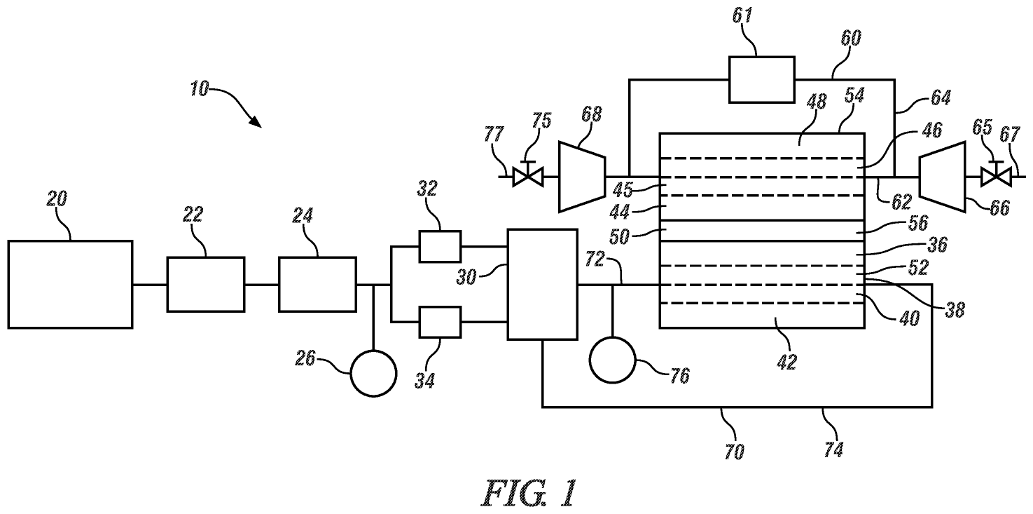

Referring now to the drawings, wherein like numerals indicate like elements, a fuel cell system is shown and described herein. FIG. 1 is a schematic perspective view of a fuel cell system 10 according to an embodiment of the disclosure. As illustrated, the fuel cell system 10 includes a fuel cell stack 50, a hydrogen storage tank 20, a fuel injector 32 and a fuel injector 34 supplying flows of hydrogen gas to an ejector device 30. For simplicity, the fuel cell stack 50 is illustrated as a single fuel cell including an anode 52 and a cathode 54 separated by a fuel cell membrane 56 (or polymer electrolyte membrane (PEM)). However, it is to be understood that the fuel cell system 10 may include a plurality of fuel cell stacks 50 including a plurality of pairs of anodes 52 and cathodes 54.

As viewed in the drawing, the fuel cell membrane or PEM 56 is sandwiched or otherwise disposed between the anode 52 and the cathode 54. Proceeding outward from the PEM 56, the anode 52 includes a catalyst layer 36 (or anode substrate), a micro-porous layer 38, a gas diffusion layer 40 and a bipolar plate 42. Similarly, proceeding outward from the PEM 56, the cathode 54 includes a catalyst layer 44 (or cathode substrate), a micro-porous layer 45, a gas diffusion layer 46 and a bipolar plate 48.

An anode gas loop 70 including a hydrogen gas flow is provided to the anode 52. A cathode gas subsystem 60 including a compressed air flow is provided to the cathode 54. As described herein, the fuel cell stack 50 utilizes the hydrogen gas flow at the anode 52 and the compressed air at the cathode 54 to produce electrical energy for use by a vehicle or system equipped with the fuel cell stack 50.

Hydrogen gas is supplied by hydrogen storage tank 20 at high pressure. Shut-off valve 22 is provided and is capable of selectively permitting or not permitting hydrogen gas from the hydrogen storage tank 20 to flow to a remainder of the fuel cell system 10. Pressure regulator 24 is provided which controls and steps down the pressure of hydrogen gas from the high pressure delivered by hydrogen storage tank 20 to a medium pressure to be delivered to the fuel injector 32 and the fuel injector 34. A pressure sensor 26 is provided between the pressure regulator 24 and the two fuel injectors 32, 34.

The fuel injector 32 and the fuel injector 34 are operable to selectively open and supply hydrogen gas to the anode gas loop 70 and to selectively close and prohibit hydrogen gas from flowing into the anode gas loop 70. Hydrogen gas is delivered to the fuel injector 32 and the fuel injector 34 at medium pressure. The fuel injector 32 and the fuel injector 34 supply hydrogen gas to the anode gas loop 70 at a low pressure by cycling between an open state and a closed state, opening to increase pressure to a maximum desired anode gas loop pressure, closing when the pressure within the anode gas loop 70 reaches the maximum desired anode gas loop pressure, and opening again when the pressure within the anode gas loop 70 reaches a minimum desired anode gas loop pressure. By opening the fuel injector 32 and the fuel injector 34 when the pressure within the anode gas loop 70 reaches the minimum desired anode gas loop pressure and by closing the fuel injector 32 and the fuel injector 34 when the pressure within the anode gas loop 70 reaches the maximum desired anode gas loop pressure, the fuel injector 32 and the fuel injector 34 may be used to maintain the pressure within the anode gas loop 70 within a desired low pressure range.

The ejector device 30 is a device useful to provide hydrogen gas from the fuel injector 32 and from the fuel injector 34 into the anode gas loop 70. The ejector device 30 includes a venturi configuration. Hydrogen gas flowing through the ejector device 30 flows past a venturi tube within the ejector device 30. The anode gas loop 70 includes an upstream portion 72 upstream of the anode 52 and a downstream portion 74 downstream of the anode 52. The upstream portion 72 includes a high concentration of hydrogen gas. As the hydrogen gas goes through the anode 52, a significant portion of the hydrogen gas may be consumed by the anode 52. However, a lower concentration of hydrogen gas may remain in the downstream portion 74. The downstream portion 74 is connected to the venturi tube of the ejector device 30, such that the movement of hydrogen gas from the fuel injector 32 and the fuel injector 34, through the ejector device 30, and into the upstream portion 72 flows past the venturi device and draws gas from the downstream portion 74 into the gas flowing into the upstream portion 72. In this way, gas from the downstream portion 74 is recycled through the anode 52. A pressure sensor 76 is disposed to monitor a pressure within the upstream portion 72.

Water as a by-product of the chemical reaction of the fuel cell stack 50 may exit the anode 52. The downstream portion 74 may include an anode water separator and an anode drain valve useful to drain the water from the downstream portion 74.

Air is provided to the cathode 54 to supply oxygen for the fuel cell stack reaction. An air compressor 66 is provided for drawing in ambient air and providing a pressurized flow of air through the cathode gas subsystem 60. Flow through the air compressor 66 is controlled via an isolation valve 65, which is a flow control valve that is controllable to manage airflow to the fuel cell stack 50, including being controllable to block airflow between the fuel cell stack 50 and atmosphere 77 via pipe 67. In one embodiment, the isolation valve 65 is arranged upstream of the air compressor 66. Alternatively, the isolation valve 65 is arranged downstream of the air compressor 66. The cathode gas subsystem 60 includes a cathode reactant portion 62 and a cathode bypass portion 64. The cathode reactant portion 62 provides a flow of air to the cathode 54. A bypass valve 61 is connected to the cathode bypass portion 64, and control of the bypass valve 61 may be used to control how much air flows through the cathode bypass portion 64 and how much air flows through the cathode reactant portion 62. This control of how much air flows through the cathode reactant portion 62 may be important to controlling the reaction of the fuel cell stack 50. Air exits to atmosphere 77 through an air expander device 68. Flow through the air expander device 68 is controlled via an exhaust valve 75, which is a flow control valve that is controllable to manage airflow to the fuel cell stack 50, including being controllable to block airflow between the fuel cell stack 50 and atmosphere 77. In one embodiment, the exhaust valve 75 is arranged upstream of the air expander device 68. Alternatively, the exhaust valve 75 is arranged downstream of the air expander device 68.

During operation of the fuel cell stack 50, as briefly mentioned above, hydrogen gas enters channels formed in the anode bipolar plate 42 and flows across the anode gas diffusion layer 40, the micro-porous layer 38, and the catalyst layer 36. Likewise, oxygen or air enters channels formed in the cathode bipolar plate 48 and flows across the cathode gas diffusion layer 46, the micro-porous layer 45, and the catalyst layer 44. As the hydrogen gas that enters the anode layers is oxidized, the hydrogen molecule is electrocatalytically dissociated into a proton and an electron, and the electrons flow in an electrical circuit, for example through a load (not shown), from the anode bipolar plate 42 to the cathode bipolar plate 48. Meanwhile, the remaining portions of the oxidized hydrogen atoms (which are protons) are transported across the fuel cell stack 50 from the anode 52 side to the cathode 54 side via membrane 56, where they combine with the incoming air and the anode-derived electrons that were introduced to the electrical circuit.

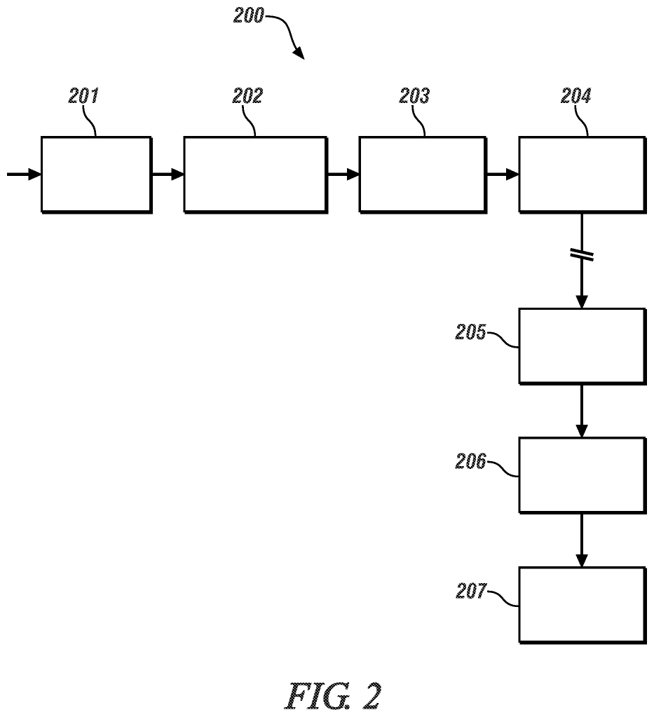

FIG. 2 schematically illustrates a method 200 that is executable on an embodiment of the fuel cell system 10 that is described with reference to FIG. 1 to provide a system and associated method that minimizes or eliminates a risk of oxidation of the carbon black particles contained in an embodiment of the fuel cell stack 50 of the fuel cell system 10 during extended periods of inactivity, e.g., during shipping or long-term storage of the fuel cell.

The method 200 includes fabricating an embodiment of the fuel cell system 10 including fuel cell stack (FC Stack) 50 described with reference to FIG. 1, wherein the cathode (or alternatively, the anode) includes a carbon support and platinum-based catalyst nanoparticles that are dispersed on the carbon support (Step 201).

In anticipation of shipping and/or storage of the fuel cell stack 50, the fuel cell stack 50 is purged with a premixed gas that contains carbon monoxide (or CO) therethrough (Step 202) and sealing the fuel cell stack 50 to prevent intrusion of outside air into the fuel cell stack 50 during shipping and/or storage (Step 203). Sealing the fuel cell stack 50 may include closing the exhaust valve 75.

Purging the fuel cell with a premixed gas that contains carbon monoxide (or CO) therethrough (Step 202) may include flowing a premixed gas containing carbon monoxide and hydrogen in one embodiment. This may include purging both the anode and the cathode with a mixture of carbon monoxide and hydrogen, in one embodiment. Alternatively, this may include purging the anode with a mixture of carbon monoxide and hydrogen, and purging the cathode with an inert gas, e.g., nitrogen, argon, or helium.

The hydrogen and carbon monoxide work together within the fuel cell stack 50. The hydrogen pins the electrochemical potential of the platinum to zero volts and allows the carbon monoxide to adsorb onto the platinum. The carbon monoxide is stable as long as hydrogen is in proximity. By adsorbing carbon monoxide onto platinum, the electrodes are no longer active toward hydrogen oxidation reaction (HOR) and hydrogen evolution reaction (HER). The high diffusivity and high permeability of hydrogen relative to oxygen and the low concentration and intrusion rate of oxygen confine oxygen to a small portion of the fuel cell for a period of time. As more oxygen leaks into the fuel cell, it reacts with hydrogen and carbon monoxide in its way, creating water or CO₂, and cleans the platinum surface without causing carbon corrosion.

Flowing the premixed gas containing carbon monoxide and hydrogen may include flowing the premixed gas containing hydrogen (H₂) and carbon monoxide (CO) at a volumetric ratio of 99.95% H₂ to 0.05% CO. This may include, in one embodiment, the premixed gas containing at least 10 parts per million (ppm) of CO in one embodiment.

Flowing the premixed gas containing carbon monoxide and hydrogen may include flowing the premixed gas containing at least 0.1% concentration of CO therethrough in one embodiment. This may include, in one embodiment, the premixed gas containing at least 10 ppm of CO in one embodiment.

Alternatively, flowing the premixed gas containing carbon monoxide may include flowing a premixed gas containing carbon monoxide and nitrogen. This may include, in one embodiment, the premixed gas containing at least 0.1% concentration of CO in one embodiment. This may include, in one embodiment, the premixed gas containing at least 10 ppm of CO in one embodiment.

Alternatively, flowing the premixed gas containing carbon monoxide may include flowing a premixed gas containing carbon monoxide and argon. This may include, in one embodiment, the premixed gas containing at least 0.1% concentration of CO in one embodiment. This may include, in one embodiment, the premixed gas containing at least 10 ppm of CO in one embodiment.

Alternatively, flowing the premixed gas containing carbon monoxide may include flowing a premixed gas containing carbon monoxide and helium. This may include, in one embodiment, the premixed gas containing at least 0.1% concentration of CO in one embodiment. This may include, in one embodiment, the premixed gas containing at least 10 ppm of CO in one embodiment.

Alternatively, flowing the premixed gas containing carbon monoxide may include flowing a premixed gas containing another inert gas and helium. This may include, in one embodiment, the premixed gas containing at least 0.1% concentration of CO in one embodiment. This may include, in one embodiment, the premixed gas containing at least 10 ppm of CO in one embodiment.

The fuel cell stack 50 may be shipped and/or stored (Step 204). This may include assembling the fuel cell stack 50 into an embodiment of the fuel cell system 10, if this has not already occurred.

In this manner, the fuel cell stack is protected from intrusion of oxygen and associated corrosion of the carbon support of the second catalyst layer during storage by imposition of carbon monoxide gas on the first and/or second catalyst layers.

Subsequent to removal of the fuel cell stack 50 from storage, the exhaust valve 75 is opened to unseal the fuel cell stack 50 (Step 205), and a refresh operation is executed to purge the CO from the fuel cell stack 50 (Step 206). Executing the refresh operation to purge the carbon monoxide from the fuel cell stack 50 includes flowing ambient air through the fuel cell stack 50. In one embodiment, this includes flowing ambient air through the cathode 54. In one embodiment, this includes flowing ambient air through the cathode 54 and hydrogen through the anode 42 with or without a small amount of electric load for a period of time.

The fuel cell system 10 including the fuel cell stack 50 is able to operate (Step 207) to generate electrical power from tractive and other purposes.

In this manner the carbon support of the second catalyst layer of the fuel cell stack is protected from corrosion that may otherwise occur during storage by imposition of carbon monoxide gas on the second catalyst layer prior to operation. Also, the carbon support of the second catalyst layer of the fuel cell stack may be protected from corrosion that may otherwise occur during storage by imposition of carbon monoxide gas on the first and second catalyst layers prior to operation.

For the sake of brevity, techniques related to signal processing, data fusion, signaling, control, and other functional aspects of the systems (and the individual operating components of the systems) may not be described in detail herein. Furthermore, the connecting lines shown in the various figures contained herein are intended to represent example functional relationships and/or physical couplings between the various elements. Alternative or additional functional relationships or physical connections may be present in an embodiment of the present disclosure.

The term “controller” and related terms such as microcontroller, control, control unit, processor, etc. refer to one or various combinations of Application Specific Integrated Circuit(s) (ASIC), Field-Programmable Gate Array(s) (FPGA), electronic circuit(s), central processing unit(s), e.g., microprocessor(s) and associated non-transitory memory component(s) in the form of memory and storage devices (read only, programmable read only, random access, hard drive, etc.). The non-transitory memory component is capable of storing machine readable instructions in the form of one or more software or firmware programs or routines, combinational logic circuit(s), input/output circuit(s) and devices, signal conditioning, buffer circuitry and other components, which may be accessed by and executed by one or more processors to provide a described functionality. Input/output circuit(s) and devices include analog/digital converters and related devices that monitor inputs from sensors, with such inputs monitored at a preset sampling frequency or in response to a triggering event. Software, firmware, programs, instructions, control routines, code, algorithms, and similar terms mean controller-executable instruction sets including calibrations and look-up tables. Each controller executes control routine(s) to provide desired functions. Routines may be executed at regular intervals, for example every 100 microseconds during ongoing operation. Alternatively, routines may be executed in response to occurrence of a triggering event. Communication between controllers, actuators and/or sensors may be accomplished using a direct wired point-to-point link, a networked communication bus link, a wireless link, or another communication link. Communication includes exchanging data signals, including, for example, electrical signals via a conductive medium; electromagnetic signals via air; optical signals via optical waveguides; etc. The data signals may include discrete, analog and/or digitized analog signals representing inputs from sensors, actuator commands, and communication between controllers.

The flows, methods, and processes described below and in the accompanying figures are merely representative of functions that may be performed in particular embodiments. In other embodiments, additional functions may be performed in the flows, methods, and processes. Various embodiments of the present disclosure contemplate mechanisms for accomplishing the functions described herein. Some of the functions illustrated herein may be repeated, combined, modified, or deleted within the flows, methods, and processes where appropriate. Additionally, functions may be performed in any suitable order within the flows, methods, and processes without departing from the scope of particular embodiments.

The detailed description and the drawings or figures are supportive and descriptive of the present teachings, but the scope of the present teachings is defined solely by the claims. While some of the best modes and other embodiments for carrying out the present teachings have been described in detail, various alternative designs and embodiments exist for practicing the present teachings defined in the claims.

What is claimed is:

1. A method for operating a fuel cell system, the method comprising:
assembling a fuel cell stack including an exhaust valve and an isolation valve;
flowing a premixed gas containing carbon monoxide therethrough; and
closing the exhaust valve and the isolation valve.

2. The method of claim 1, further comprising:
opening the exhaust valve and the isolation valve; and
executing a refresh operation to purge the carbon monoxide from the fuel cell stack.

3. The method of claim 2, wherein executing the refresh operation to purge the carbon monoxide from the fuel cell stack comprises flowing ambient air through the fuel cell stack.

4. The method of claim 2, wherein the fuel cell stack includes an anode and a cathode; and
wherein executing the refresh operation to purge the carbon monoxide from the fuel cell stack comprises flowing ambient air through the cathode.

5. The method of claim 1, wherein flowing the premixed gas containing carbon monoxide therethrough comprises flowing a premixed gas containing carbon monoxide and hydrogen therethrough.

6. The method of claim 5, wherein flowing the premixed gas containing carbon monoxide and hydrogen comprises flowing the premixed gas containing hydrogen (H₂) and carbon monoxide (CO) at a ratio of 99.9% H₂ to 0.1% CO.

7. The method of claim 1, wherein flowing the premixed gas containing carbon monoxide therethrough comprises flowing a premixed gas containing carbon monoxide and nitrogen.

8. The method of claim 1, wherein flowing the premixed gas containing carbon monoxide therethrough comprises flowing a premixed gas containing carbon monoxide and argon.

9. The method of claim 1, wherein flowing the premixed gas containing carbon monoxide therethrough comprises flowing a premixed gas containing carbon monoxide and helium.

10. The method of claim 1, wherein flowing the premixed gas containing carbon monoxide therethrough comprises flowing a premixed gas containing at least 0.1% concentration of CO therethrough.

11. A method for operating a fuel cell stack, the method comprising:
flowing a gas containing carbon monoxide through the fuel cell stack for a predetermined time period; and then
sealing, via an exhaust valve and an isolation valve, the fuel cell stack to prevent intrusion of air.

12. The method of claim 11, further comprising executing a refresh operation to purge the carbon monoxide from the fuel cell stack.

13. The method of claim 12, wherein executing the refresh operation to purge the carbon monoxide from the fuel cell stack comprises opening the exhaust valve and the isolation valve, and flowing ambient air through the fuel cell stack.

14. The method of claim 12, wherein the fuel cell stack includes an anode and a cathode; and
wherein executing the refresh operation to purge the carbon monoxide from the fuel cell stack comprises flowing ambient air through the cathode.

15. The method of claim 11, wherein flowing the gas containing carbon monoxide therethrough comprises flowing a premixed gas containing carbon monoxide and hydrogen therethrough.

16. The method of claim 15, wherein flowing the gas containing carbon monoxide and hydrogen comprises flowing the premixed gas containing hydrogen (H₂) and carbon monoxide (CO) at a ratio of 99.95% H₂ to 0.05% CO.

17. The method of claim 11, wherein flowing the gas containing carbon monoxide therethrough comprises flowing a premixed gas containing carbon monoxide and nitrogen.

18. The method of claim 11, wherein flowing the gas containing carbon monoxide therethrough comprises flowing a premixed gas containing carbon monoxide and argon.

19. The method of claim 11, wherein flowing the gas containing carbon monoxide therethrough comprises flowing a premixed gas containing at 10 ppm (parts per million) of CO therethrough.

20. A fuel cell system, comprising:
a fuel cell stack, including an anode and a cathode that are separated by a fuel cell membrane;
the anode having a first catalyst layer, a first micro-porous layer, a first gas diffusion layer and a first bipolar plate;
the cathode having a second catalyst layer, a second micro-porous layer, a second gas diffusion layer, and a second bipolar plate; and
the second catalyst layer including a carbon support and platinum-based catalyst nanoparticles that are dispersed on the carbon support;
wherein the carbon support of the second catalyst layer of the fuel cell stack is protected from corrosion during storage by imposition of carbon monoxide gas on the second catalyst layer.
